(19) United States
(12) Patent Application Publication
(10) Pub. No.: US 2008/0067918 A1
(43) Pub. Date: Mar. 20, 2008

(54) LIGHT EMITTING MODULE

(75) Inventors: Takeshi IWASAKI, Shizuoka-shi (JP); Hisayoshi DAICHO, Shizuoka-shi (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 11/846,547

(22) Filed: Aug. 29, 2007

(30) Foreign Application Priority Data
Sep. 19, 2006 (JP) 2006-252742

(51) Int. Cl. H01J 1/00

(52) U.S. Cl. 313/503

(57) ABSTRACT

A light emitting module using a light emitting phosphor having a high brightness and an excellent color rendering property in the case where it is used as a white light emitting module in place of a red light emitting phosphor, is provided. The light emitting module includes a semiconductor light emitting device having a light emitting peak wavelength from 350 to 420 nm, and a phosphor layer for emitting a light by a light transmitted from the semiconductor light emitting device to be an excitation light source. The phosphor layer includes an orange phosphor having at least an α type Ca pyrophosphate crystal structure represented by Ca_{2-X-Y-Z}M_{X}P₂O₇:Eu_{Y}, Mn_{Z}, where M represents an alkali earth element other than Ca, and X≧0, Y>0 and Z>0.

This application is based on and claims priority from Japanese Patent Application No. 2006-252742, filed on Sep. 19, 2006, the entire contents of which are hereby incorporated by reference.

### BACKGROUND OF THE INVENTION

1. Technical Field

The present invention relates to a light emitting module using an orange phosphor having a high brightness and an excellent color rendering property.

2. Background Art

There has been developed an illuminating light source in which mercury is not used in respect of environmental issues and power saving concerns, and in which a light emitting diode (LED) or a semiconductor laser (LD) is combined as an excitation light source with a phosphor and a light emission at that time is set to be a light source, so that power consumption can be lower.

For example, Japanese Patent No. 2927279 discloses a light emitting diode for wholly emitting a white-based light based on an additive color mixture with a blue light emitted from an LED and a yellow light emitted from a Ce-activated rare earth aluminate phosphor that absorbs a part of a blue light and emits a light. Referring to this combination type, however, a luminescent color of a white light that is finally obtained is restricted, and furthermore, a reproducibility of a color under an illumination of the light source is not obtained in a preferable color, and thus a color rendering property has drawbacks. In addition, there are variations in the amounts of phosphors disposed on an optical path of a light emission from the light emitting diode. For this reason, there is also a problem that the ratios of a blue light and a yellow light are not stabilized, and thus a luminescent color of a light emitting module is not stabilized.

In recent years, in order to solve the above-described problem, a light emitting module in which an ultraviolet light or a visible light of a short-wavelength is set to be a primary light (an excitation light) emitted from a semiconductor light emitting device and phosphors having three components for green, blue and red colors (additive color mixture) is mixed, is introduced as a method of compensating for a drawback caused by a white-color synthesis in a two-color addition (e.g., see Japanese Unexamined Patent Publication:JP-A-2004-127988) Herein, BaMgAl₁₀O₁₇: EU²⁺ (hereinafter referred to as BAM) and (Sr, Ca, Ba)₅(PO₄)₃Cl:Eu²⁺ are taken as a blue light emitting phosphor. Ca₈Mg(SiO₄)₄Cl:Eu²⁺, Mn²⁺ and BaMgAl₁₀O₁₇:Eu²⁺, Mn²⁺ are taken as a green light emitting phosphor. Y₂O₂S:Eu³⁺ (YOS:Eu) and Y₂O₃:Eu, Bi and La₂O₂S:EU₃₊ (LOS:Eu) are taken as a red light emitting phosphor.

In the phosphors for emitting the red, green and blue lights, however, light emission efficiency of the red light emitting phosphor is lower than the phosphors for emitting the green and blue lights. In order to obtain a desirable white light (e.g., chromaticity: x/y=0.360/0.365), therefore, a mixing rate in the red light emitting phosphor is set to be higher than that of the phosphors for emitting the green and blue colors, for example, a compounding ratio is caused to approximate to 90%. For this reason, the compounding ratio of the green and blue light emitting phosphors having high light emitting efficiencies is reduced so that a light emitting module for emitting a white light having a high brightness cannot be obtained.

In the red light emitting phosphor, LOS:Eu (hereinafter referred to as LOS) has been developed in a “lamp in 21st century” project, which is a Japanese national project regarding white LED lighting technology, and is a great red light emitter at present and is also set to be a standard product of the red light emitting phosphor.

However, the excitation peak wavelength is 340 nm and is widely different from a maximum output wavelength (400 nm) in an ultraviolet LED chip. For this reason, there is a problem that a light emission having a sufficient brightness cannot be obtained in the excitation light having the wavelength of 400 nm.

Moreover, an emission spectrum of LOS has a sharp light emitting peak at a wavelength of 624 nm and a sufficient color rendering property cannot be obtained in the white light emitting module through the additive color mixture using the red light emitting phosphor.

### SUMMARY OF THE INVENTION

Accordingly, aspects of the present invention solve the above-described problems and provide a light emitting module using a light emitting phosphor having a high brightness and an excellent color rendering property in the case where it is used as a white light emitting module in the place of a red light emitting phosphor.

Such is achieved by employing the following:

(1) A light emitting module comprising:

a semiconductor light emitting device having a light emitting peak wavelength from 350 to 420 nm; and

a phosphor layer for emitting a light by a light transmitted from the semiconductor light emitting device to be an excitation light source, the phosphor layer including an orange phosphor having at least an α type Ca pyrophosphate crystal structure represented by

Ca_{2-X-Y-Z}M_{X}P₂O₇:Eu_{Y}, Mn_{Z}

wherein M represents an alkali earth element other than Ca, X≧0, Y>0 and Z>0.

(2) The phosphor layer may include the orange phosphor and at least one phosphor having another color, and emit a white light.

(3) Furthermore, the light emitting module may have characteristics such that 0.01≦Y≦0.3 and 0.01≦Z≦0.3.

(4) Furthermore, the light emitting module may have characteristics such that 0.2≦(Z/Y+Z)≦0.8.

(5) The phosphor layer may include the orange phosphor and either a blue phosphor and a green phosphor, and emit a white light.

(6) The blue phosphor may be Ca apatite.

The orange phosphor included in the phosphor layer of the light emitting module according to an exemplary embodiment of the present invention has features of (a) the peak wavelength of an excitation spectrum is in the vicinity of 400 nm to be a maximum output wavelength range of an ultraviolet LED chip, (b) a light emitting peak wavelength is 600 nm, which has a higher luminous efficacy than that of a red light, and (c) a light emitting (integrated) intensity is higher than that of conventional LOS, so that a high brightness can be obtained in the case in which the orange phosphor is used in the light emitting module.

Moreover, the orange light emitter included in the phosphor layer of the light emitting module according to the invention has a feature of (d) an emission spectrum is broad so that an excellent color rendering property can be obtained in the case in which the orange light emitter is used in the light emitting module.

The orange phosphor included in the light emitting module according to the invention has a higher light emission efficiency than that of the conventional red light emitting phosphor and is excellent in a luminous efficacy and a brightness. Therefore, it is possible to obtain a module which has a high efficiency and is excellent in brightness and color rendering properties.

### BRIEF DESCRIPTION OF THE DRAWINGS

In the accompanying drawings:

FIG. 1 is a schematic view showing an example of a configuration of a white light emitting module using an orange phosphor according to an exemplary embodiment of the present invention;

FIG. 2 is a chromaticity diagram showing a preferable range of a degree of whiteness of a light emitted from the white light emitting module using the orange phosphor according to an exemplary embodiment of the present invention;

FIG. 3 is a chromaticity diagram showing a more preferable range of the degree of whiteness of the light emitted from the white light emitting module using the orange phosphor according to an exemplary embodiment of the present invention;

FIG. 4 is a graph showing an emission spectrum distribution of Ca pyrophosphate used in a first example;

FIG. 5 is a graph showing an excitation spectrum distribution of the Ca pyrophosphate used in the first example;

FIG. 6 is a graph showing an emission spectrum distribution of LOS used in a comparative example;

FIG. 7 is a graph showing an excitation spectrum distribution of LOS used in the comparative example;

FIG. 8 is a graph showing an emission spectrum distribution of BAM:EuMn used in the examples and the comparative example;

FIG. 9 is a graph showing an emission spectrum distribution of Sr aluminate used in the examples;

FIG. 10 is a graph showing an emission spectrum distribution of Sr thiogallate used in the examples;

FIG. 11 is a graph showing an emission spectrum distribution of BOS used in the examples;

FIG. 12 is a graph showing an emission spectrum distribution of Ca apatite used in the examples;

FIG. 13 is a graph showing an emission spectrum distribution of BAM used in the examples;

FIG. 14 is a graph showing an emission spectrum distribution of Sr apatite used in the examples;

FIG. 15 is a graph showing a white light emission spectrum distribution according to the first example and the comparative example;

FIG. 16 is a graph showing a white light emission spectrum distribution according to a fourth example and the comparative example;

FIG. 17 is a graph showing a white light emission spectrum distribution according to a seventh example and the comparative example; and

FIG. 18 is a graph showing a white light emission spectrum distribution according to a tenth example and the comparative example.

### DETAILED DESCRIPTION OF EXEMPLARY EMBODIMENTS

An orange phosphor included in a light emitting module according to exemplary embodiments of the present invention is characterized as having an a type Ca pyrophosphate crystal structure and is represented by the following formula.

Ca_{2-X-Y-Z}MxP₂O₇:Euy, Mnz

(In the formula, M represents an alkali earth element other than Ca and X≦0, Y>0 and Z>0 are set.)

The orange phosphor represented by the above-described formula has an excitation peak wavelength in a range of 350 to 420 nm including 390 to 410 nm in which a maximum value of an external quantum efficiency of an InGaN/GaNbased semiconductor light emitting device is obtained. Moreover, a light emitting peak wavelength is in the vicinity of 600 nm and a broad emission spectrum is obtained. In the case where the orange phosphor is used in a light emitting module, therefore, it is possible to obtain a light emitting module in which a brightness and a color rendering property are improved more greatly than a conventional light emitting module.

In the orange phosphor represented by the formula, a sum (Y+Z) of activated metal europium (Eu) and manganese (Mn) is not particularly limited but a sum of 0.1 to 0.6 is preferable and a sum of 0.15 to 0.45 is more preferable.

Moreover, it is preferable that amounts of the activated metal europium (Eu) and the manganese (Mn) should be 0.01≦Y≦0.3 and 0.01≦Z≦0.3.

In the orange phosphor represented by the above-described formula, furthermore, a ratio Z/Y+Z of Mn in a total activator (Eu+Mn) is not particularly limited but is preferably in a range of 0.2 to 0.8.

The orange phosphor used in the light emitting module according to the invention is not particularly limited but a particle diameter is preferably 50 μm or less. Since the particle diameter is equal to or smaller than 50 μm, it is possible to prevent a light from being scattered in a particle surface of the phosphor, thereby causing the phosphor to efficiently emit a light.

The light emitting module according to exemplary embodiments of the invention can also use, as a component, a phosphor for emitting a light having another color. For example, it is possible to obtain a white light emitting module by combining a semiconductor light emitting device for emitting an ultraviolet light with blue and green light emitting phosphors.

In this case, while the blue light emitting phosphor and the green light emitting phosphor are further used basically in addition to the orange phosphor, it is also preferable to further use other phosphors in order to obtain a white color having a more desirable chromaticity.

In the case where only an orange phosphor (O), a green light emitting phosphor (G) and a blue light emitting phosphor (B) are used as light emitters, their compounding ratio is preferably in a range of (O) 35 to 75: (G) 15 to 50:(B) 2 to 30 and is more preferably in a range of (O) 45 to 74:(G) 20 to 45:(B) 5 to 15 in a spectrum fraction ratio.

The blue light emitting phosphor used together with the orange phosphor preferably has a light emitting peak wavelength of 400 to 500 nm and the green light emitting phosphor preferably has a light emitting peak wavelength of 500 to 550 nm.

For the blue light emitting phosphors a Ca apatite phosphor represented by (CaMgEu)₅(PO₄)₃Cl, an Sr apatite phosphor represented by (SrEu)₅ (PO₄)₃Cl, and BAM are used, and the Ca apatite phosphor is preferable.

For the Ca apatite phosphor, a phosphor represented by the following formula is preferable.

Ca_{5-X-Y}Mg_{X}Eu_{Y} (PO₄)₃Cl

(0.05≦X≦2.5, 0<Y<0.5)

For the green light emitting phosphor, there are used an Sr aluminate phosphor represented by SrAl₂O₄:Eu, an (Sr, Ba) orthosilicate based phosphor represented by (Sr_{1-X-Y-Z}Ba_{X}Ca_{Y}Eu_{Z})₂SiO₄, an Sr thiogallate phosphor represented by SrGaS₄:Eu, and a BAM:EuMn phosphor.

Together with the orange phosphor to be used in the light emitting module according to the present invention, moreover, it is also preferable to properly use a red light emitting phosphor and an orange phosphor that have conventionally been known well and used publicly.

The red phosphor, which is well known and publicly used, includes a red phosphor as described in the background art of the present specification.

Regarding the orange phosphor that is essential for the light emitting module, the blue light emitting phosphor and the green light emitting phosphor that can be used together, and the red light emitting phosphor and the orange phosphor that are well known and publicly used, it is preferable that they have a resistance to ultraviolet rays.

According to a semiconductor light emitting device used in the light emitting module of exemplary embodiments of the present invention using the orange phosphor, it is not particularly limited if the light emitting peak wavelength is in a range of 350 to 420 nm. However, it is preferable to use a general InGaN/GaN based semiconductor light emitting device as a semiconductor light emitting device for emitting ultraviolet rays. In detail, it is preferable to suitably use a semiconductor light emitting device that hase been described in Japanese Unexamined Patent Publication: JP-A-2002-17100.

In the InGaN/GaN based semiconductor light emitting device, a light emitting peak wavelength is shifted toward long-wavelength sides when an amount of In is increased, and is shifted toward short-wavelength sides when the amount of In is decreased. In order to apply the InGaN/GaN based semiconductor light emitting device to the light emitting module, accordingly, the amount of In is property regulated in such a manner that a light emitting peak wavelength is in a range of 350 to 420 nm.

The light emitting module according to exemplary embodiments of the present invention comprises the semiconductor light emitting device and a phosphor including the orange phosphor. More specifically, it is possible to give examples of a structure in which a layer of the phosphor is provided on the semiconductor light emitting device.

In that case, the phosphor layer to be provided on the semiconductor light emitting device may be provided by laminating and disposing at least one phosphor in a single layer or a plurality of layers or may be provided by mixing and disposing a plurality of phosphors in a single layer. Examples of configurations in which the phosphor layer is provided on the semiconductor light emitting device include a configuration in which a phosphor is mixed into a coating member for covering a surface of the semiconductor light emitting device, a configuration in which a phosphor is mixed into a molding member or a configuration in which the phosphor is mixed into a covering member for covering the molding member therewith, and furthermore, a configuration in which a plate capable of transmitting a light, with which a phosphor is mixed, is disposed in front of a light emitting side of a semiconductor light emitting device lamp. In the case in which the phosphor is mixed into the molding member, it is preferable that the phosphor should be dispersed in a silicone resin having an excellent UV resisting property.

Moreover, at least one phosphor may be added to the molding member provided on the semiconductor light emitting device. Furthermore, at least one phosphor layer in the phosphor may be provided on an outside of the light emitting module. Examples of configurations in which the phosphor is provided on the outside of the light emitting module include a configuration in which a phosphor is coated in a layer shape on a surface at the outside of the molding member of the light emitting module, a configuration in which a molded member (taking a shape of a cap, for example) having a phosphor dispersed into rubber, a resin or an elastomer is fabricated and the semiconductor light emitting device is coated therewith, or a configuration in which the molded member is processed in a plate shape and is disposed in front of the semiconductor light emitting device.

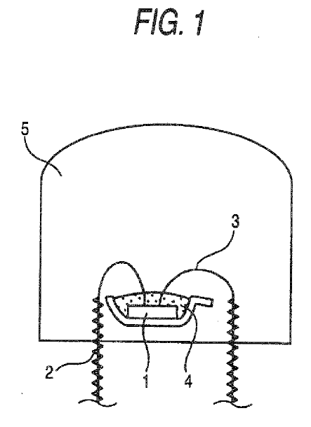

FIG. 1 shows an example of a specific configuration of the light emitting module using the orange phosphor according to exemplary embodiments of the invention. In the light emitting module shown in FIG. 1, 1 denotes a short-wavelength visible light LED chip having an InGaN active layer and a central wavelength in the vicinity of 395 nm. The short-wavelength visible light LED chip 1 is fixed to a lead frame 2 through an adhesive layer. The short-wavelength visible light LED chip 1 and the lead frame 2 are electrically connected to each other through a metal wire 3. The short-wavelength visible light LED chip 1 is covered with a phosphor paste 4 in which phosphor powder is kneaded into a binder resin. Examples of the binder resin of the phosphor paste 4 include a silicone resin, an epoxy resin, an urethane resin, a norbornene based resin, a fluororesin, metal alkoxide, polysilazane, and an acrylic resin. Moreover, the light emitting module has a sealing member 5 for covering the phosphor paste 4. The sealing member 5 includes materials that are transparent to a visible light, for example, a silicone resin, an epoxy resin, an urethane resin, a norbornene based resin, a fluororesin, an acrylic resin and a low melting glass.

The configuration for the light emitting module is not limited to the light emitting module structure but the light emitting module may have various configurations, for example, a light emitting surface of the short-wavelength visible light LED chip 1 is coated with a phosphor layer.

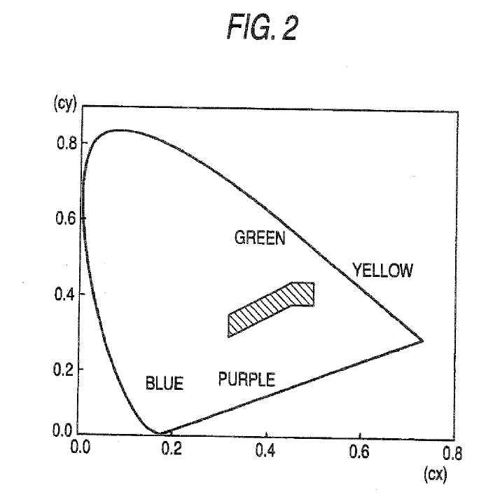

In the case in which the light emitting module according to an exemplary embodiment of the present invention is set to be a white light emitting module, it is preferable to have a predetermined degree of whiteness. More specifically, the degree of whiteness is within the following numeric value specifying range, which is a whiteness definition of a lighting device for a vehicle of JIS D 5500, and preferably corresponds to a hatching region in FIG. 2 if shown in a chromaticity diagram.

Yellow direction x≦0.50

Blue direction x≧0.31

Green direction y≦0.44 and y≦0.15+0.64x

Purple direction y≧0.05+0.75x and y≧0.382

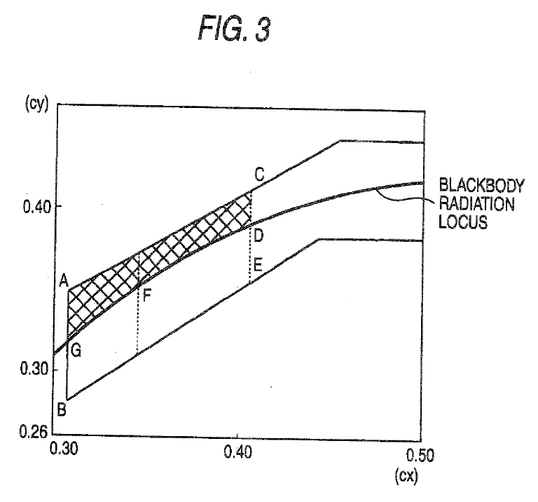

A more preferable whiteness degree specifying range is as follows and corresponds to a hatching region in FIG. 3 if shown in a chromaticity diagram.

0.310≦x≦0.405 and blackbody radiation locus ≦y≦0.15+0.64x

Description will be given to a color rendering property of a white light emitting module using the orange phosphor according to exemplary embodiments of the invention.

The color rendering property is an index indicative of a degree that a color of a reflected light obtained by irradiating a measuring light to a sample is close to an actual color of the sample. A numeric value has a maximum of 100. When the numeric value is increased, the color rendering property is higher (more excellent). More specifically, a value indicative of a degree that the color of the reflected light obtained by irradiating the measuring light to the sample is close to the actual color of the sample (a color in the case in which an ideal white light is irradiated; 100 is max) is measured for various samples (specified colors) and an average value thereof is represented by Ra.

Although the color rendering property of the white light emitting module using the orange phosphor according to exemplary embodiments of the invention which approximates to 100 is more preferable, it is not particularly limited but is desirably 60 or more.

### EXAMPLE

While the invention will be more specifically described below with reference to non-limiting examples, the scope of the invention is not limited thereto.

### Example 1

Ca pyrophosphate (Ca_{1.7}Eu_{0.2}Mn_{0.1})P₂O₇ being used as a red phosphor, BAM:Eu, Mn (KASEI OPTONIX LTD.: KX-671) being used as a green phosphor, and Ca apatite ((Ca_{4.67}Mg_{0.25}Eu_{0.08})₅(PO₄)₃Cl) being used as a blue phosphor are mixed to have a CIE chromaticity (cx, cy)=(0.360, 0.365). Consequently, a spectrum fraction ratio of 54:38:8 is obtained. The mixture is mixed with a silicone resin (Dow Corning Toray Co., Ltd.: JCR6126) in a ratio of 1:1, and then film thereof is formed in a thickness of 200 μm on an optical glass, and curing is carried out at 150° C. for one hour to fabricate a phosphor filter. The phosphor filter is disposed on an emitting surface of a surface-mounting type light emitting module using an InGaN/GaN based semiconductor light emitting device and an LED is conducted in 20 mA to evaluate the luminous flux and the color rendering property of the emitted light. As a result, an average color rendering index (Ra) is 84 and a total luminous flux is enhanced by 1.9 times as that in a comparative example.

The Ca pyrophosphate and the Ca apatite are synthesized by the following method.

[A method of synthesizing Ca pyrophosphate: (Ca_{1.7}Eu_{0.2}Mn_{0.1}) P₂O₇]

CaHPO₄, EU₂O₃, MnCO₃ and (NH₄)H₂PO₄ are measured in a molar ratio of 1.7:0.1:0.1:0.3. After uniform mixing, the mixture is sintered at a temperature of 1120 to 1250° C. for 1-3 hours in an N₂ atmosphere containing 5% of H₂ by means of an alumina crucible with a cover and is thus synthesized.

### [A method of synthesizing Ca apatite (Ca_{4.42}Mg_{0.5}Eu_{0.08})(PO₄)₃Cl]

CaCO₃, MgCO₃, Eu₂O₃, CaCl₂ and CaHPO₄ are measured in a molar ratio of 0.17:0.5:0.04:1.25:3.0. After uniform mixing, the mixture is sintered at a temperature of 1200° C. for 3 hours in an N₂ atmosphere containing 5% of H₂ by means of an alumina crucible with a cover and is thus synthesized.

### Example 2

Ca pyrophosphate (Ca_{1.7}Eu_{0.2}Mn_{0.1})P₂O₇, BAM:Eu being used as a red phosphor, BAM:Eu, Mn (KASEI OPTONIX LTD.: KX-671) being used as a green phosphor and Sr apatite ((SrEu)₅(PO₄)₃Cl) (KASEI OPTONIX LTD.: KX-663) being used as a blue phosphor are respectively mixed to have a CIE chromaticity (cx, cy)=(0,360, 0.365). Consequently, a spectrum fraction ratio of 52:39:9 is obtained. In the same manner as in example 1, subsequently, a phosphor filter is fabricated to evaluate the light emitting characteristic. As a result, Ra is 86 and a total luminous flux is enhanced by 1.8 times as that in the comparative example.

### COMPARATIVE EXAMPLE

LOS (KASEI OPTONIX LTD.: KX-681) being used as a red phosphor, BAM:Eu, Mn (KASEI OPTONIX LTD. KX-671) being used as a green phosphor, and BAM (KASEI OPTONIX LTD.: KX-661) being used as a blue phosphor are respectively mixed so as to obtain a CIE chromaticity (cx, cy)=(0.360, 0.365). Consequently, the spectrum fraction ratio of 66:26:8 is obtained. In the same manner as in example 1, subsequently, a phosphor filter is fabricated to evaluate the light emitting characteristic, Consequently, Ra is 37.

### Examples 3 through 12

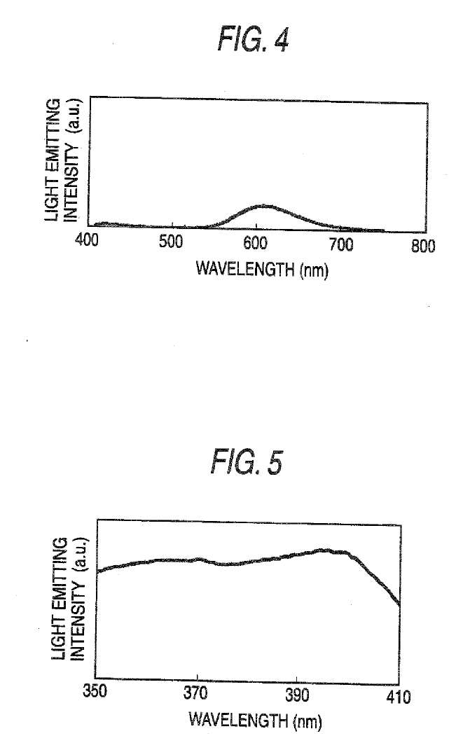

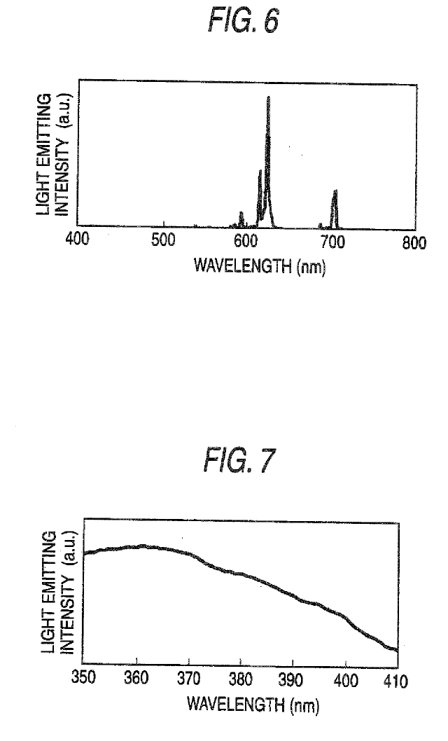

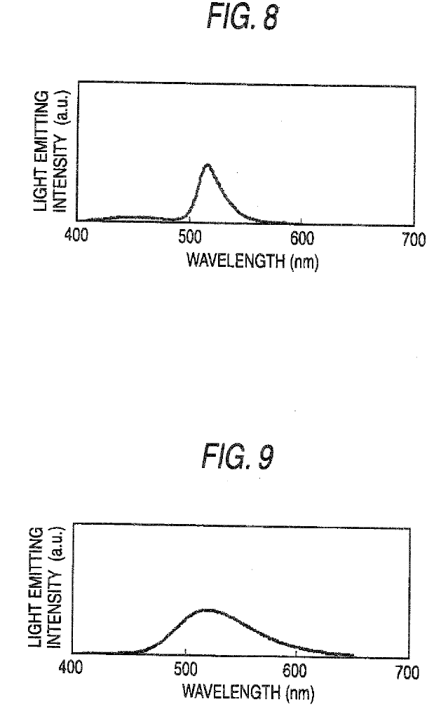

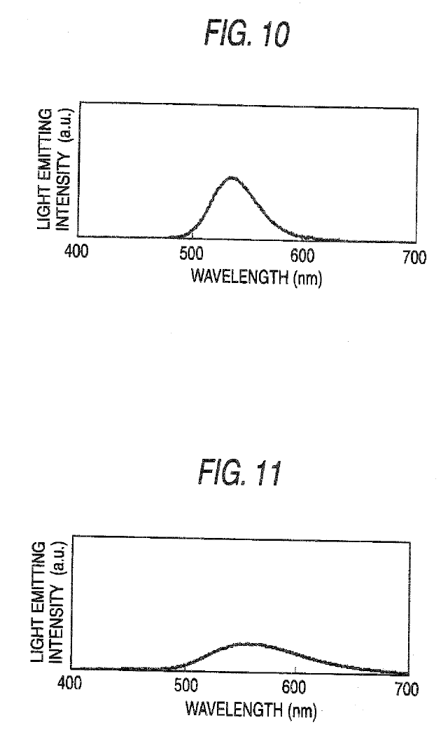

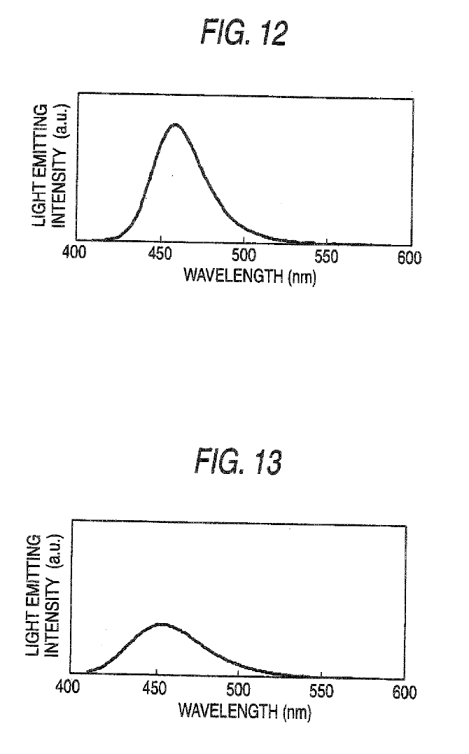

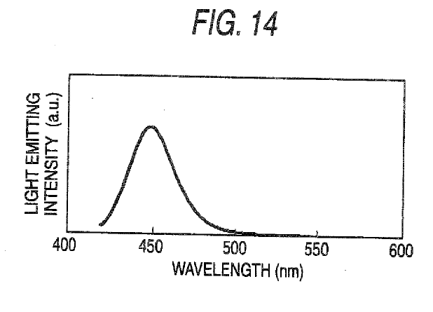

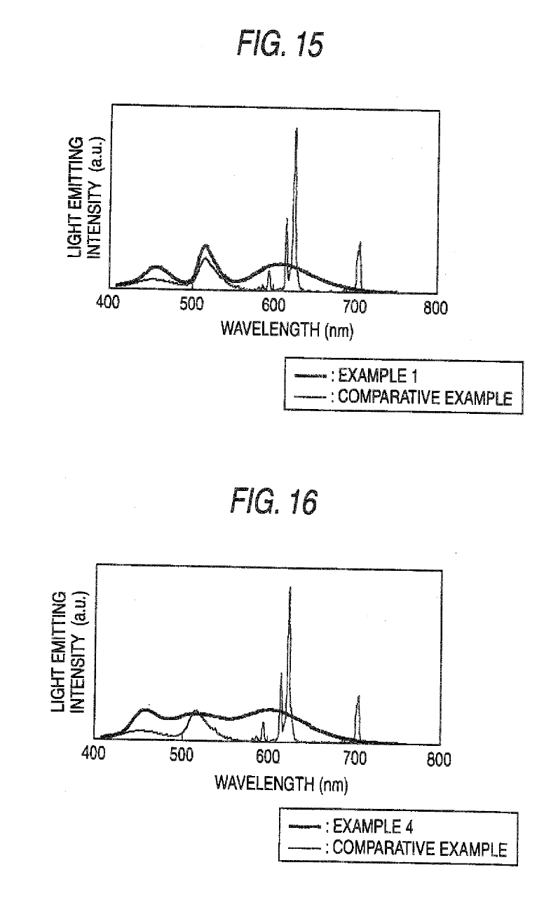

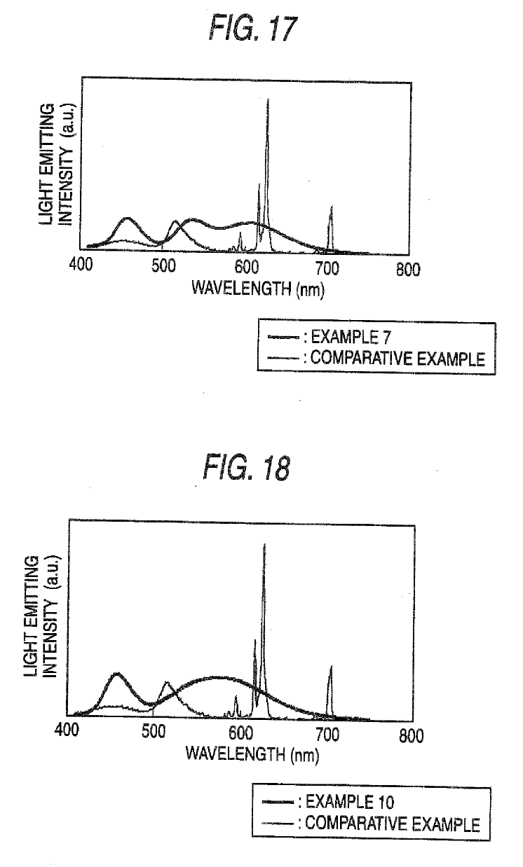

In the same manner as in examples 1 and 2, a light emitting characteristic is measured with a composition shown in Table 1. FIGS. 4 to 14 show an emission spectrum and an excitation spectrum for Ca pyrophosphate and LOS, and an emission spectrum for the other phosphors, as used phosphors. Table 1 and FIGS. 15 to 18 show a result of the evaluation of the light emitting characteristics according to the examples and the comparative example.

Referring to (Sr, Ba) orthosilicate of the green phosphor, WLY450 (Intemaics Co., Ltd.) is used. A method of manufacturing Sr aluminate and Sr thiogallate is as follows.

[Synthesis of Sr aluminate: Sr_{0.8}Al₂O₄:EU_{0.2}]

SrCO₃, Eu₂O₃ and α alumina are measured in a molar ratio of 0.8:0.1:1.0. After uniform mixing, the mixture is sintered at a temperature of 1200° C. for 3 hours in an N₂ atmosphere containing 5% of H₂ by means of an alumina crucible with a cover and is thus synthesized.

[Synthesis of Sr thiogallate:Sr_{0.85}Ga₂S₄:Eu_{0.15}]

Ga₂S₃, SrS and Eu₂O₃ are measured in a molar ratio of 1.0:0.85:0.075. After uniform mixing, the mixture is sintered at a temperature of 1000° C. for 8 hours in an N₂ atmosphere by means of an alumina crucible with a cover and is thus synthesized.

TABLE 1

| | | | | Spectrum | | | Light emitting | |
|---|---|---|---|---|---|---|---|---|
| | | | | fraction | | | Characteristic | |
| | Phosphor | | | ratio | | | | Total luminous |
| Example | R | G | B | R | G | B | Ra | flux ratio |
| 1 | Ca pyrophosphate | BAM:EuMn | Ca apatite | 54 | 38 | 8 | 89 | 1.9 |
| 2 | Ca pyrophosphate | BAM:EuMn | Sr apatite | 52 | 39 | 9 | 86 | 1.8 |
| 3 | Ca pyrophosphate | BAM:EuMn | BAM | 51 | 35 | 14 | 85 | 1.8 |
| 4 | Ca pyrophosphate | Sr aluminate | Ca apatite | 59 | 28 | 13 | 91 | 2.7 |
| 5 | Ca pyrophosphate | Sr aluminate | Sr apatite | 55 | 29 | 16 | 94 | 2.6 |
| 6 | Ca pyrophosphate | Sr aluminate | BAM | 53 | 25 | 22 | 93 | 2.4 |
| 7 | Ca pyrophosphate | Sr thiogallate | Ca apatite | 60 | 25 | 15 | 87 | 2.6 |
| 8 | Ca pyrophosphate | Sr thiogallate | Sr apatite | 55 | 27 | 18 | 79 | 2.5 |
| 9 | Ca pyrophosphate | Sr thiogallate | BAM | 54 | 22 | 24 | 87 | 2.3 |
| 10 | Ca pyrophosphate | (Sr,Ba) orthosilicate | Ca apatite | 25 | 58 | 17 | 75 | 2.9 |
| 11 | Ca pyrophosphate | (Sr,Ba) orthosilicate | Sr apatite | 17 | 61 | 22 | 68 | 2.8 |
| 12 | Ca pyrophosphate | (Sr,Ba) orthosilicate | BAM | 23 | 50 | 27 | 76 | 2.5 |
| Comparative | LOS | BAM:EuMn | BAM | 66 | 26 | 8 | 37 | 1.0 |
| example | | | | | | | | |

From the Table 1 and FIGS. 15 to 18, it is apparent that both Ra and the total luminous flux are enhanced more greatly than those in conventional LOS in the case where a Ca pyrophosphate phosphor is used as a red light of a white light emitting module having 3 wavelengths using an InGaN/GaN type semiconductor light emitting device. Referring to the Table 1, moreover, it is apparent from the results of examples 1,4,7 and 10 that both Ra and the total luminous flux are excellent in the case in which the Ca apatite is used for the blue light emitting phosphor.

As shown in FIG. 4, the Ca pyrophosphate has a peak in the vicinity of 600 nm and is broader than LOS. As shown in FIG. 5, moreover, it is apparent that an excitation spectrum is broad in a near ultraviolet area and a relative intensity of the excitation spectrum is higher than that of LOS in the vicinity of 400 nm.

While the invention has been described in connection with exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A light emitting module comprising:
a semiconductor light emitting device having a light emitting peak wavelength from 350 to 420 nm; and
a phosphor layer that emits a light by a light transmitted from the semiconductor light emitting device to be an excitation light source, the phosphor layer including an orange phosphor having at least an a type Ca pyrophosphate crystal structure represented by
Ca_{2-X-Y-Z}M_{X}P₂O₇:Eu_{Y}, Mn_{Z}
wherein M represents an alkali earth element other than Ca, and X≧0, Y>0 and Z>0.

2. The light emitting module according to claim 1, wherein the phosphor layer includes the orange phosphor and at least one phosphor having another color, and emits a white light.

3. The light emitting module according to claim 1, wherein 0.01≦Y≦0.3 and 0.01≦Z≦0.3.

4. The light emitting module according to claim 2, wherein 0.01≦Y≦0.3 and 0.01≦Z≦0.3.

5. The light emitting module according to claim 1, wherein 0.2≦(Z/Y+Z)≦0.8.

6. The light emitting module according to claim 2, wherein 0.2≦(Z/Y+Z)≦0.8.

7. The light emitting module according to claim 3, wherein 0.2≦(Z/Y+Z)≦0.8.

8. The light emitting nodule according to claim 4, wherein 0.2≦(Z/Y+Z)≦0.8.

9. The light emitting module according to claim 2, wherein the phosphor layer includes the orange phosphor and either one of a blue phosphor and a green phosphor, and emits a white light.

10. The light emitting module according to claim 3, wherein the phosphor layer includes the orange phosphor and either one of a blue phosphor and a green phosphor, and emits a white light.

11. The light emitting module according to claim 4, wherein the phosphor layer includes the orange phosphor and either one of a blue phosphor and a green phosphor, and emits a white light.

12. The light emitting module according to claim 5, wherein the phosphor layer includes the orange phosphor and either one of a blue phosphor and a green phosphor, and emits a white light.

13. The light emitting module according to claim 6, wherein the phosphor layer includes the orange phosphor and either one of a blue phosphor and a green phosphor, and emits a white light.

14. The light emitting module according to claim 7, wherein the phosphor layer includes the orange phosphor and either one of a blue phosphor and a green phosphor, and emits a white light.

15. The light emitting module according to claim 8, wherein the phosphor layer includes the orange phosphor and either one of a blue phosphor and a green phosphor, and emits a white light.

16. The light emitting module according to claim 9, wherein the blue phosphor is Ca apatite.

17. The light emitting module according to claim 10, wherein the blue phosphor is Ca apatite.

18. The light emitting module according to claim 11, wherein the blue phosphor is Ca apatite.

19. The light emitting module according to claim 12, wherein the blue phosphor is Ca apatite.

20. The light emitting module according to claim 13, wherein the blue phosphor is Ca apatite.
